(19) United States
(12) Patent Application Publication
(10) Pub. No.: US 2007/0068076 A1
(43) Pub. Date: Mar. 29, 2007

(54) HYDROGEN GENERATING DEVICE AND FUEL CELL SYSTEM

(76) Inventors: Yoshiyuki Isozaki, Tokyo (JP); Fuminobu Tezuka, Yokohama-shi (JP); Yuusuke Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/470,931

(22) Filed: Sep. 7, 2006

(30) Foreign Application Priority Data
Sep. 28, 2005 (JP) 2005-281654

(51) Int. Cl. B01J 8/00

(52) U.S. Cl. 48/127.9; 422/211; 422/198

(57) ABSTRACT

A hydrogen generating device comprises a first plate having plural first grooves, plural first walls which define the first grooves, an alumina layer formed by anodic oxidation at least in part of the surface of the first walls, and a first catalyst layer containing heteropolyacid to be carried on the alumina layer, and a second plate arranged oppositely to the first plate, the second plate having plural second grooves formed to correspond to the first grooves one by one, plural second walls which define the second grooves, and a second catalyst layer formed at least in part of the surface of the second walls. The first walls are inserted into the second grooves, and the second walls are inserted into the first grooves, whereby the first and second walls are located opposite to each other and apart from each other by not larger than 500 μm, respectively.

### CROSS-REFERENCE TO RELATED APPLICATIONS

This application is based upon and claims the benefit of priority from prior Japanese Patent Application No. 2005-281654, filed Sep. 28, 2005, the entire contents of which are incorporated herein by reference.

### BACKGROUND OF THE INVENTION

1. Field of the Invention

The invention relates to a hydrogen generating device and a fuel cell system, and more particularly to a hydrogen generating device and a fuel cell system suited to reduction in size.

2. Description of the Related Art

Recently, electronic appliances such as portable telephones, video cameras, and computers have been reduced more and more in size along with progress in semiconductor technology, and a higher portable performance is demanded. As a power source for satisfying such a demand, hitherto, a handy primary battery or secondary battery has been used. However, the primary battery or secondary battery is functionally limited in operation time, and an electronic appliance using such a battery is limited in the time of use.

That is, when a primary battery is used, the battery is replaced after the battery is completely discharged, and the electronic appliance can be operated. However, its time of use is short for its weight, and it is not suited to a portable appliance. A secondary battery can be recharged after being discharged completely, but a power source for charging is needed. For this reason, not only the place of use is limited, but also charging takes a long time. In particular, in an electronic appliance, etc. incorporating a secondary battery, it is hard to replace the battery even if the battery is discharged completely, and therefore, limitation of time of use of the appliance is inevitable. Thus, to operate various small appliances for a long time, a conventional primary battery and secondary battery are hardly applicable if improved or modified, and a new battery suited to operation for a longer time is being demanded.

As one of the measures for solving these problems, a fuel cell is noticed recently. A fuel cell not only can generate power only by supplying a fuel and an oxidizing agent, but also can generate power continuously by refilling with a fuel. For this reason, it is expected to be a very useful system for operation of a portable electronic appliance if it can be reduced in size.

In the field of general fuel cells, a fuel cell system is developed by using soft hydrocarbon such as natural gas and naphtha or alcohol such as methanol as a material, and combining with a fuel cell main body. The fuel cell main body reforms the material by a reformer containing a catalyst for reforming inside to generate reformed gas containing hydrogen, supplies the reformed gas to a fuel electrode (anode) of a fuel cell, and supplies air into an oxidant electrode (cathode) to generate power. As compared with a direct type methanol fuel cell using a liquid fuel such as methanol, an output voltage is higher and a higher efficiency is obtained in such a fuel cell system. Therefor, small size and high performance can be expected.

Aside from alcohols, various other fuels are being studied. Among the other fuels, dimethyl ether is lower in toxicity as compared with methanol, and is liquefied at room temperature, and it is therefore noticed for its ease in storage and transportation.

Hitherto, dimethyl ether has been reformed at high temperature of 700° C. or higher. At 700° C. or higher, dimethyl ether is decomposed directly to become methane. Therefore, any conventional catalyst used in reforming natural gas can be used, such as nickel (Ni)/alumina or ruthenium (Ru)/alumina. However, to heat dimethyl ether at 700° C. or higher, a heating device of large scale is needed, and to protect surrounding parts from heat, a thick insulating layer is needed to be provided in the reformer, which makes it difficult to reduce the entire size of the fuel cell system.

Accordingly, catalysts capable of reforming dimethyl ether at low temperature have been developed.

JPA 2003-047853 (KOKAI) incorporated by reference proposes, as a dimethyl ether reforming catalyst, a catalyst containing a reforming catalyst component having platinum carried on a carrier having a solid acid action, and a CO shift catalyst component for CO shift reaction for removing byproduct Co. Further, JPA 2003-154268 (KOKAI) incorporated by reference discloses a method of manufacturing a dimethyl ether reforming catalyst, comprising preparing the catalyst by mixing active alumina in a precursor mixture containing zinc and palladium, and a catalyst prepared by the method.

Even by employing these methods, however, reaction temperature of 350° C. to 450° C. is needed to obtain a high reforming rate, and the temperature is not low enough for using the fuel cell as the power source for a portable electronic appliance.

V. V. Galvita et al. Have reported in Applied Catalysis, A216, 85-90, 2001 incorporated by reference, as a dimethyl ether reforming catalyst, a catalyst prepared by physically mixing γ-alumina powder carrying silicotungstic acid, and copper-silica catalyst (Cu/SiO₂) serving as a methanol reforming catalyst. According to the reference, a conversion rate of dimethyl ether at 300° C. is approximately 100%. However, what they are using is powder catalyst having a particle size of 0.25 to 0.5 mm. When the reformer is filled with the catalyst, pressure loss increases and heat transfer resistance increases. Therefore, a large reactor is needed, and consequently, the hydrogen generating device and fuel cell system are increased in size.

### BRIEF SUMMARY OF THE INVENTION

According to one aspect of the present invention, there is provided a hydrogen generating device comprising a reforming unit to obtain reformed gas containing hydrogen from a fuel containing dimethyl ether and water, the reforming unit comprising:

a first path plate having a plurality of first penetration grooves adjacent to one another, a plurality of first walls which define the first penetration grooves, an alumina layer formed by anodic oxidation at least in part of the surface of the first walls, and a first catalyst layer containing heteropolyacid to be carried on the alumina layer; and

a second path plate arranged oppositely to the first path plate, the second path plate having a plurality of second penetration grooves formed so as to correspond to the first penetration grooves one by one, a plurality of second walls which define the second penetration grooves, and a second catalyst layer formed at least in part of the surface of the second walls,

wherein the first walls are inserted into the second penetration grooves, and the second walls are inserted into the first penetration grooves, whereby the first walls and second walls are located opposite to each other and apart from each other by not larger than 500 μm inclusive 500 μm, respectively.

According to another aspect of the present invention, there is provided a fuel cell system comprising:

a reforming unit to obtain reformed gas including hydrogen from a fuel including dimethyl ether and water; and

a fuel cell which receives supply of the reformed gas from the reforming unit,

the reforming unit comprising:

a first path plate having a plurality of first penetration grooves adjacent to one another, a plurality of first walls which define the first penetration grooves, an alumina layer formed by anodic oxidation at least in part of the surface of the first walls, and a first catalyst layer containing heteropolyacid to be carried on the alumina layer; and

a second path plate arranged oppositely to the first path plate, the second path plate having a plurality of second penetration grooves formed so as to correspond to the first penetration grooves one by one, a plurality of second walls which define the second penetration grooves, and a second catalyst layer formed at least in part of the surface of the second walls,

wherein the first walls are inserted into the second penetration grooves, and the second walls are inserted into the first penetration grooves, whereby the first walls and second walls are located opposite to each other and apart from each other by not larger than 500 μm inclusive 500 μm, respectively.

### BRIEF DESCRIPTION OF THE SEVERAL VIEWS OF THE DRAWING

FIG. 1 is a block diagram showing a fuel cell system according to an embodiment of the invention;

FIG. 2 is a perspective view schematically showing a reformer of the fuel cell system in FIG. 1;

FIG. 3 is an exploded perspective view of the reformer in FIG. 2;

FIG. 4 is a sectional view showing a first path plate and a second path plate of the reformer in FIG. 2;

FIG. 5 is a sectional view showing a penetration groove structure composed of the first path plate and second path plate in FIG. 4;

FIG. 6 is a partially enlarged sectional view of the first path plate in FIG. 4;

FIG. 7 is a partially enlarged sectional view of the second path plate in FIG. 4;

FIG. 8 is a partially enlarged sectional view of the penetration groove structure in FIG. 5;

FIG. 9A is an exploded sectional view showing a first path plate and a second path plate of a hydrogen generating device in Example 1;

FIG. 9B is an assembled sectional view showing the first path plate and second path plate of the hydrogen generating device in Example 1;

FIG. 10 is an electron microscope image showing an alumina layer formed by anodic oxidation on the first path plate of the hydrogen generating device in Example 1;

FIG. 11 is a characteristic diagram showing the relation between a reforming temperature and a conversion rate of dimethyl ether in the hydrogen generating device in Examples 1 to 4 and Comparative example 1; and

FIG. 12 is a characteristic diagram showing time-course changes of a DME conversion rate in retrial of a reforming test of dimethyl ether at 275° C. with respect to the hydrogen generating device in Example 3.

### DETAILED DESCRIPTION OF THE INVENTION

Embodiments of the present invention will be described below with reference to the accompanying drawings.

The fuel cell system includes a hydrogen generating device 1 and a fuel cell 2, as shown in FIG. 1. The hydrogen generating device 1 has fuel supply means 3. The fuel supply means 3 contains a mixture of dimethyl ether and water as a fuel for the fuel cell system. The fuel may be, for example, a mixture of dimethyl ether and water, or a mixture of dimethyl ether, water, and alcohol. As the alcohol, methanol or ethanol is preferably used, and in particular, methanol is preferred because the mutual dissolving property of dimethyl ether and water is improved.

As the fuel supply means 3, for example, a pressure container which is attachable to and detachable from the fuel cell system may be used. By making use of pressure of dimethyl ether, the fuel can be sent into a vaporizing unit (vaporizer) 4 described below.

The mixing ratio (molar ratio) of dimethyl ether and water is ideally 1:3 stoichiometrically. In an actual fuel cell system, however, production of carbon monoxide increases if the mixing ratio is close to 1:3. Further, since excess water can be used in shift reaction or power generation as mentioned below, it is preferred to define at 1:3.5 or more. However, since in the vaporizing unit 4, the energy for heating and vaporizing the fuel is increased, the mixing ratio is preferred to be 1:5.0 or less, or ideally 1:4.0 or less.

The hydrogen generating device 1 includes the vaporizing unit 4. The vaporizing unit 4 is connected to the fuel supply means 3 by piping or the like. The fuel sent into the vaporizing unit 4 is heated and vaporized.

The hydrogen generating device 1 also includes a reforming unit (reformer) 5. The reforming unit 5 is connected to the vaporizing unit 4 by piping or the like. Dimethyl ether of the vaporized fuel sent into the reforming unit 5 is first decomposed into methanol by hydrolysis of dimethyl ether as a first stage reaction shown in formula (1), and subsequently, is reformed into hydrogen and carbon dioxide by steam reforming of methanol as a second stage reaction shown in formula (2), so that gas containing hydrogen (reformed gas) is produced.
CH₃OCH₃+H₂O [symbol] 2CH₃OH (1)
CH₃OH+H₂O [symbol] CO₂+3H₂ (2)

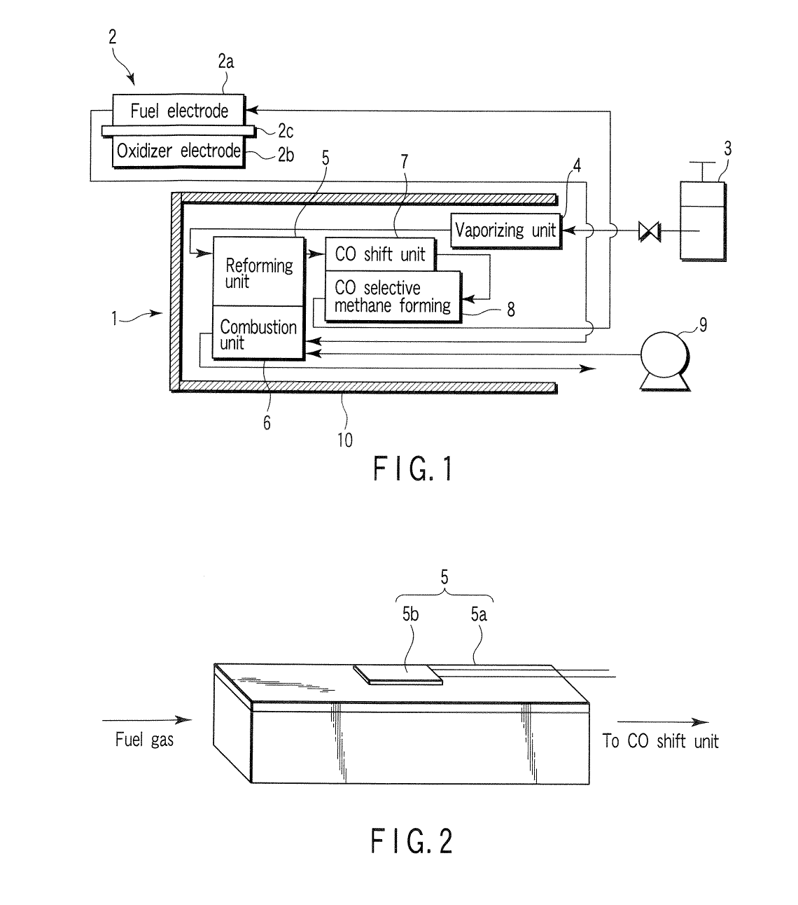

The reforming unit 5 has a housing 5a as shown in FIG. 2. In the housing 5a, first and second path plates are arranged which have first and second catalyst layers for promoting the reforming reaction formed thereon. The detail of the first and second path plates will be described later. The reforming unit 5 is heated by using a combustion unit (combustor) 6 serving as temperature holding means described below such that the temperatures of the first and second path plates are held within range of from 225° C. to 300° C. The temperature holding means may be the combustion unit 6 only, or may be a combination of the combustion unit 6 and a heating unit 5b. The heating unit 5b is, for example, a heater provided on the surface of the housing 5a of the reforming unit 5 as shown in FIG. 2. The heater 5b is, for example, a ceramic heater insulated with an alumina sheet by forming a high temperature heating element on an aluminum substrate, or a cartridge heater having high resistance metal wound around an insulator. The heater 5b receives supply of energy from outside, for example, an electric power when a cartridge heater is used as the heater 5b. Electric power to be supplied to the heater 5b is supplied from, for example, the fuel cell 2. Receiving supply of energy from outside, the heater 5b generates heat, and heats the reforming unit 5. Providing the heater 5b makes it possible to make a feedback control, and also to control the temperature of the reforming unit 5 more precisely.

The hydrogen generating device 1 may also have a CO shift unit (CO shifter) 7. The CO shift unit 7 is connected to the reforming unit 5 by piping or the like. The reformed gas reformed by the reforming unit 5 and sent into the CO shifter 7 contains byproducts, aside from hydrogen, such as carbon dioxide and carbon monoxide. Carbon monoxide deteriorates an anode catalyst of the fuel cell, and causes to lower the power generation performance of the fuel cell system. Accordingly, before supply of gas containing hydrogen into the fuel cell 2 from the reforming unit 5, the CO shifter 7 is preferred to increase the hydrogen production by reforming carbon monoxide into carbon dioxide as shown in formula (3). Inside the CO shifter 7, there is a penetration groove for passing the reformed fuel, and a shift catalyst for promoting the shift reaction of carbon monoxide contained in the reformed gas is provided in an inner wall of the penetration groove.
CO+H₂O [symbol] CO₂+H₂ (3)

A temperature of the shift reaction is preferable from 200° C. to 300° C. If the temperature of the shift reaction is lower than 200° C., the reaction speed is slow, and reforming of carbon monoxide into carbon dioxide is not promoted sufficiently. On the other hand, if the temperature of the shift reaction exceeds 300° C., carbon dioxide is transformed into carbon monoxide by reverse shift reaction, so that the CO concentration may be increased. Hence, the CO shifter 7 is heated by the combustion unit 6 such that the temperature of the catalyst is set to range of from 200° C. to 300° C.

The hydrogen generating device 1 also includes a CO selective methanation unit as a CO removing unit 8. The CO removing unit 8 is connected to the CO shift unit 7 by piping or the like. The reformed gas sent into the CO removing unit 8 after shift reaction by the CO shifter 7 still contains carbon monoxide by 1.0 molar % or less. It is, as mentioned above, a cause for lowering the power generation performance of the fuel cell system. Hence, before supply of gas containing hydrogen into the fuel cell 2 from the reforming unit 5, the CO removing unit 8 performs methanation reaction to convert carbon monoxide into methane and water as shown in formula (4), and carbon monoxide is removed until the concentration of carbon monoxide becomes 100 molar ppm or less. Inside the CO removing unit 8, a catalyst component is provided for promoting the methanation reaction of carbon monoxide contained in the reformed gas.
CO+3H₂ [symbol] CH₄+H₂O (4)

A preferred temperature of the methanation reaction is 200° C. or higher and 300° C. or lower. If the temperature of the methanation reaction is less than 200° C., the methanation reaction rate is low, and if exceeding 300° C., the methanation reaction of carbon dioxide shown in formula (2) may occur as side reaction. The methanation reaction of carbon dioxide lowers the yield of hydrogen.
CO₂+4H₂ [symbol] CH₄+2H₂O (5)

Herein, the CO removing unit 8 is heated by the combustion unit 6 such that the temperature of the catalyst component is set to not lower than 200° C. and not higher than 300° C.

The fuel cell 2 is connected to the CO removing unit 8 by piping or the like. The reformed gas being rid of carbon monoxide is sent into the fuel cell 2. The fuel cell 2 executes reaction between hydrogen in the reformed gas and oxygen in the atmosphere supplied by a pump (not shown). As a result of reaction, the fuel cell 2 produces water and generates power at the same time. A pump (not shown) is provided for supplying the atmosphere into the fuel cell 2.

The hydrogen generating device 1 further includes the combustion unit 6. Inside the combustion unit 6, there is a penetration groove in a serpentine shape or parallel path shape for passing the fuel used in power generation. In an inner wall of the penetration groove (path), there is a combustion catalyst of Pt or Pd, or alumina or the like carrying noble metal such as Pt and Pd. The reason of using noble metal in the combustion catalyst is to prevent oxidation and deterioration of the combustion catalyst without installing any accessory means for preventing oxidation and deterioration of a catalyst in the event of stopping of the fuel cell. The combustion unit 6 is communicated to the fuel cell 2 by piping or the like. In the fuel cell 2, hydrogen and oxygen react to produce water, but unreacted hydrogen is contained in the exhaust gas from the fuel cell 2. The combustion unit 6 burns the unreacted hydrogen by using the oxygen in the atmosphere supplied from a pump 9.

At this time, by making use of the combustion heat generated in the period of combustion, the vaporizing unit 4, the reforming unit 5, the CO shifter 7, and the CO removing unit 8 are heated, respectively. For efficient heating, uniform temperature, and protection of peripheral circuit parts and others from heat, the vaporizing unit 4, the reforming unit 5, the CO shifter 7, the CO removing unit 8, and the combustion unit 6 are covered with an insulating unit 10 all around. Since the reforming reaction in the reforming unit 5 is endothermic reaction and the quantity of heat necessary for the reforming reaction is great, it is preferred to form the reforming unit 5 and the combustion unit 6 in contact with each other or integrally such that the combustion heat can be efficiently transmitted from the combustion unit 6 to the reforming unit 5.

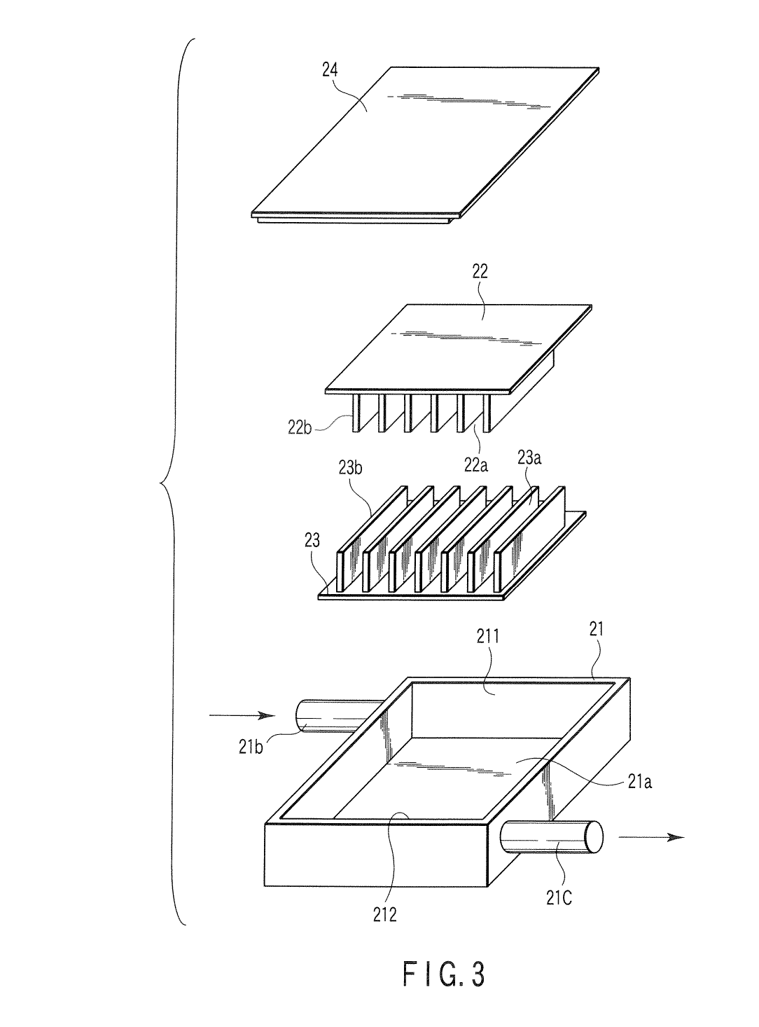

Now, the reforming unit 5 will be specifically described. FIG. 3 is an exploded perspective view of the reforming unit 5. The reforming unit 5 includes a container 21, a first path plate 22, a second path plate 23, and a lid 24.

The container 21 has a fitting portion 21a which accommodates the first path plate 22 and second path plate 23, a gas feed port 21b provided so as to communicate with the fitting portion 21a, and a gas exhaust port 21c provided at the opposite side of the gas feed port 21b so as to communicate with the fitting portion 21a.

The container 21 is formed by processing a base material. The base material preferably contains at least one material selected from the group consisting of aluminum, copper, aluminum alloy, copper alloy, and stainless steel alloy at least in part. By using a material of high heat conductivity at least in part of the base material, heat transfer property in catalyst reaction can be enhanced. Aluminum, copper, aluminum alloy and copper alloy are not only high in heat conductivity, but also excellent in processability. Stainless steel alloy is particularly preferable. A base material containing stainless steel alloy can avoid deformation of the container 21 by its internal pressure when the hydrogen generating device is used for a long time, and the durability of the hydrogen generating device can be enhanced.

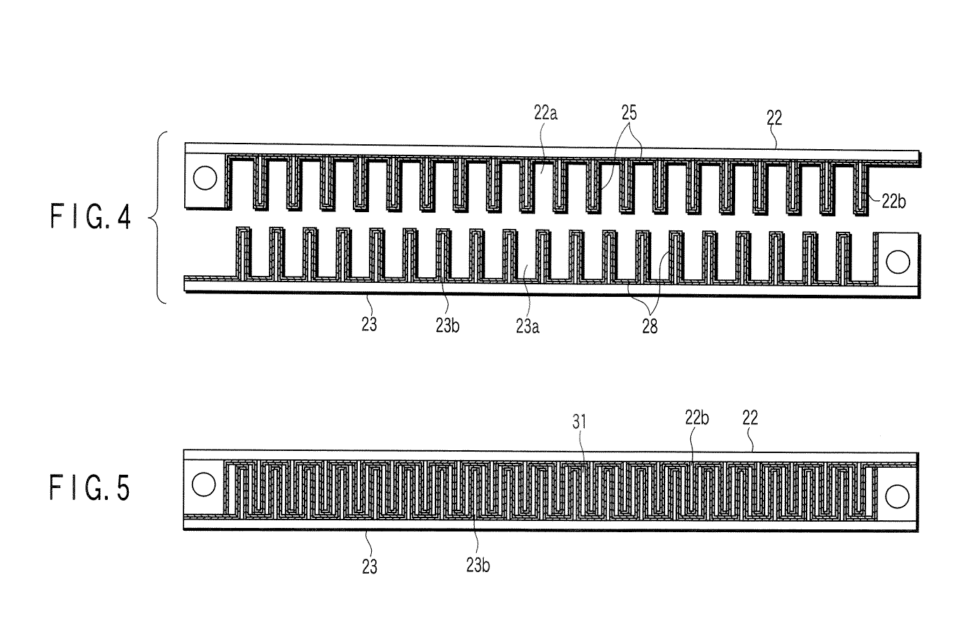

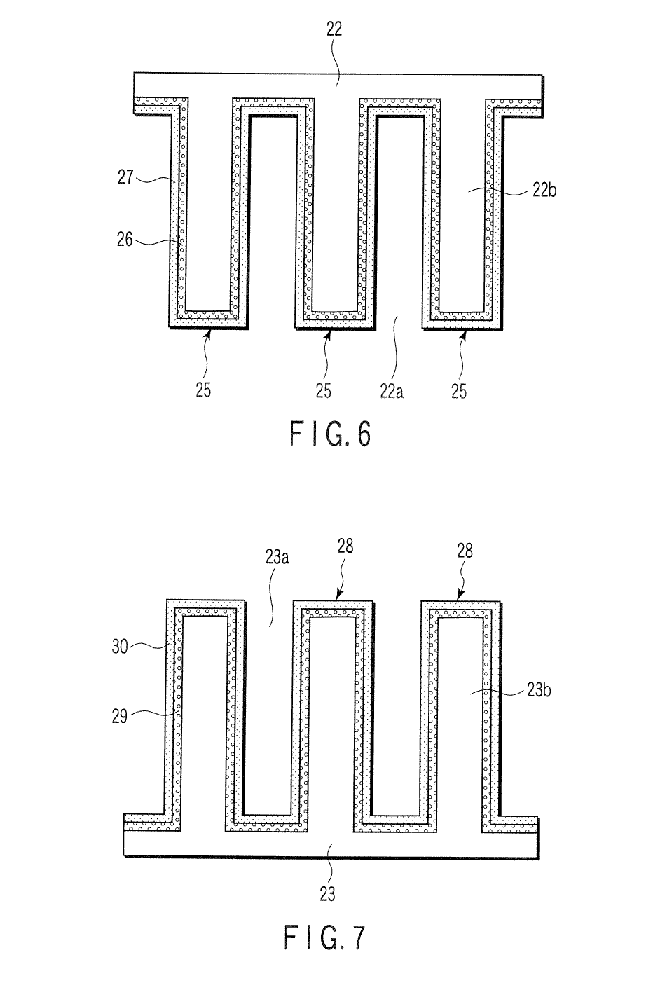

In the fitting portion 21a of the container 21, a penetration groove structure in which the second path plate 23 is fit to the first path plate 22 is accommodated. In the first path plate 22, a plurality of first penetration grooves 22a having a rectangular cross-sectional shape are formed in parallel in a mutually adjacent state as shown in FIGS. 3 and 4. Adjacent spaces of the first penetration grooves 22a share one side wall 22b. The first penetration grooves 22a have the both ends elongating in the longitudinal direction, and thus can communicate with the gas feed port 21b and the gas exhaust port 21c of the container 21. The first catalyst layer 25 includes an alumina layer 26, and a heteropolyacid 27 carried on the alumina layer 26 as shown in FIG. 6. The alumina layer 26 is formed on the side face and end face of the side wall 22b of the first penetration grooves 22a, and the bottom of the first penetration grooves 22a. On the other hand, in the second path plate 22, a plurality of second penetration grooves 23a having a rectangular cross-sectional shape are formed in parallel in a mutually adjacent state as shown in FIGS. 3 and 4. Adjacent spaces 23a of the second penetration grooves 23a share one side wall 23b. The second penetration grooves 23a have the both ends elongating in the longitudinal direction, and thus can communicate with the gas feed port 21b and the gas exhaust port 21c of the container 21. The second catalyst layer 28 includes an alumina layer 29, and a methanol reforming catalyst 30 carried on the alumina layer 29 as shown in FIG. 7. The alumina layer 29 is formed on the side face and end face of the side wall 23b of the second penetration grooves 23a, and the bottom of the second penetration grooves 23a.

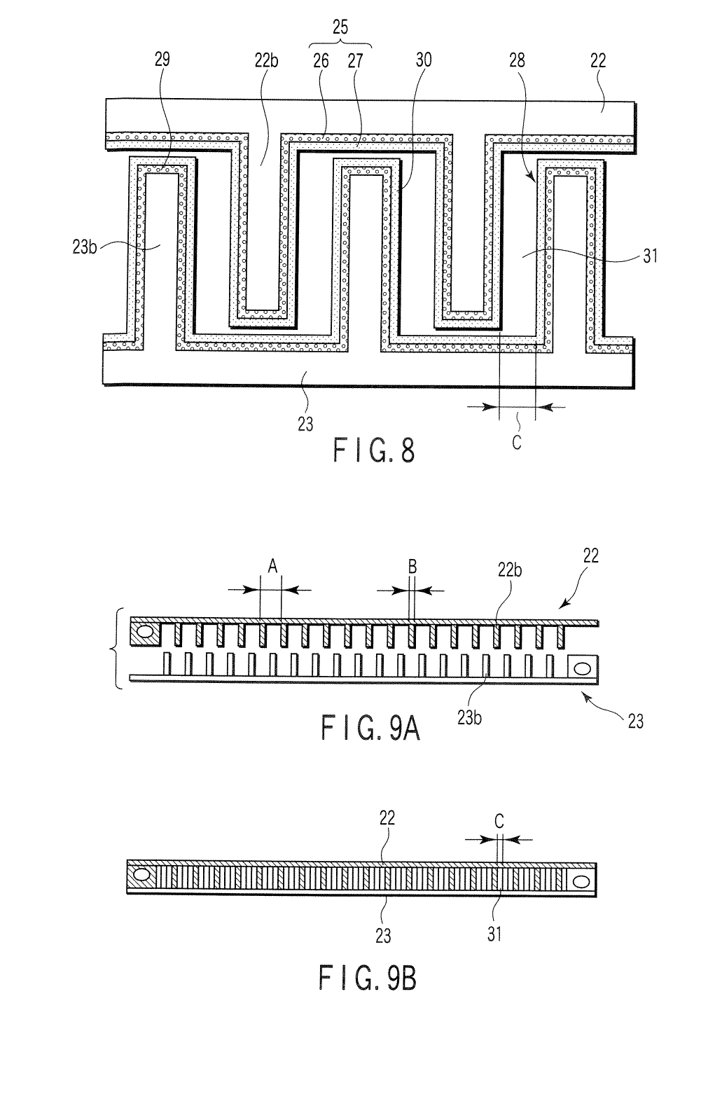

In the penetration groove structure in which the first path plate 22 is fit to the second path plate 23, the side wall 22b of the first path plate 22 is inserted in the second penetration grooves 23a of the second path plate 23 with a gap from the side wall 23b. The side wall 23b of the second path plate 23 is inserted in the first penetration grooves 22a of the first path plate 22 with a gap from the side wall 22b. As a result, as shown in FIGS. 5 and 8, the side wall 22b having the first catalyst layer 25 formed therein and the side wall 23b having the second catalyst layer 28 formed therein are arranged alternately. Further, a new parallel penetration groove 31 is formed between these side walls 22b and 23b.

The width C of the parallel path 31 is preferred to be 500 μm or less. By so defining, it is possible to reduce the diffusion resistance when the vaporized fuel gas diffuses into the wall surface, or the diffusion resistance when the produced gas diffuses into the penetration groove. Accordingly, reforming reaction to the reformed gas is promoted, and the conversion rate or the reforming rate is improved. From the viewpoint of avoiding increase of pressure loss, the lower limit of the width C is preferred to be kept at 50 μm.

The first path plate 22 and the second path plate 23 are formed by processing a base material with a general machining method or molding method. Preferably, aluminum or an aluminum alloy is used at least in part of the base material.

An example of the general machining method is discharge processing using wire (wire cutting). Wire cutting is a method of using a thin metal wire as a tool electrode, and discharging while moving the electrode or a workpiece to a desired shape. Aside from wire cutting, by using a disk blade of diamond or other abrasives fixed with resin, abrasive processing is also applicable. Abrasive processing is a method of rotating the blade at high speed and moving the blade while contacting with the workpiece, and grinding and removing a portion of the trace of the blade by abrasives to process into a desired shape. Wire cutting or abrasive processing is suited for processing grooves opening at both ends thereof, such as the penetration grooves 22a, 23a, in a short time.

A general molding method includes forging process. Forging process is a processing method in which pressure is applied to a bar or a lump metal material by using a tool, the mechanical properties of the material is improved by giving forging effects, and also the metal material is molded into a desired shape. Aside from forging process, casting process may be also applied. Casting is a processing method of pouring molten metal into a die having a cavity conforming to a desired shape, and cooling and removing the die to obtain a desired shape. Forging and casting are particularly suited for forming complicated shapes of, for example, the first and second path plates 22, 23.

The above-described penetration groove structure is accommodated in the fitting portion 21a of the container 21. At this time, the both ends of the parallel path 31 in the longitudinal direction are accommodated apart from inner walls 211, 212 of the fitting portion 21a. Penetration grooves orthogonal to the parallel penetration grooves 31 in the longitudinal direction and communicating with all the parallel paths 31 may be provided between one end of the parallel path 31 and the inner wall 211, and between the other end of the parallel path 31 and the inner wall 212. Of the two paths, the path communicating with the gas feed port 21b of the container 21 functions as a gas supply path to the parallel path 31. The path communicating with the gas exhaust port 21c of the container 21 functions as a gas exhaust path from the parallel path 31.

By covering and sealing the fitting portion 21a of the container 21 with the lid 24, the reforming unit 5 is formed which has the parallel path (penetration groove) with the feed port 21b as inlet and exhaust port 21c as outlet. That is, when the fitting portion 21a is sealed with the lid 24, the channels are formed such that the fluid supplied from the feed port 21b is discharged from the exhaust port 21c after passing through the parallel path 31.

The lid 24 is preferably formed of a base material containing at least one kind selected from the group consisting of aluminum, copper, aluminum alloy, copper alloy, and stainless steel alloy, at least in part. Aluminum, copper, aluminum alloy, and copper alloy can enhance the heat conductivity of the lid 24. Stainless steel alloy is particularly preferable. The base material containing stainless steel alloy can avoid deformation of the lid 24 by pressure in the reformer when the hydrogen generating device is used for a long period. Therefore, the durability of hydrogen generating device can be enhanced.

Now, the detail of the first catalyst layer 25 will be described. As shown in FIG. 6, the first catalyst layer 25 is formed in such a manner that at least heteropolyacid 27 and other additives as required are carried on the surface of the alumina layer 26 obtained by anodic oxidation of the surface of the aluminum portion of the first path plate 22. As described above, dimethyl ether is decomposed into methanol by hydrolysis of dimethyl ether as the first stage reaction shown in formula (1), and is reformed into hydrogen and carbon dioxide by steam reformation of methanol as the second stage reaction shown in formula (2). Generally, it is known that solid acid such as γ-alumina is effective for the first stage reaction. When solid acid having heteropolyacid carried on the alumina layer formed by anodic oxidation is used, hydrolysis of dimethyl ether is promoted outstandingly.

The heteropolyacid 27 will be specifically described below. Since the alumina layer 26 is formed by anodic oxidation, multiple fine pores are present on the surface thereof. Heteropolyacid 27 is carried on the alumina layer 26 having multiple pores by a known method such as an impregnation method. The heteropolyacid 27 may be at least one heteropolyacid selected from the group consisting of phosphotungstic acid (H₃PW₁₂O₄₀), phosphomolybdic acid (H₃PMo₁₂O₄₀) and silicotungstic acid (H₄SiW₁₂O₄₀). When a Cs acidic salt such as Cs_{2.5}H_{0.5}PW₁₂O₄₀ is used as the heteropolyacid, a solid catalyst of wide surface area composed of fine crystal particles is formed, and hydrolysis of dimethyl ether is notably promoted, which is very preferable.

The alumina layer 26 will be specifically described below. The first path plate 22 is anodically oxidized by using an acidic aqueous solution or alkaline aqueous solution, and an alumina layer 26 is formed on the surface of the aluminum portion of the first path plate 22. Thereafter, as required, pores formed in the alumina layer 26 are widened by using the acidic aqueous solution, and hydration is executed. Further, the first path plate 22 is baked for 1 hour or more at 350° C. or higher as required, preferably at 450 to 550° C. The baked alumina layer 26 becomes 7-alumina. Multiple fine pores are present on the surface of the alumina layer 26. The condition of anodic oxidation and subsequent treatment with the acidic aqueous solution is preferred to be determined such that the average pore size of the fine pores is not smaller than 5 nm and not lager than 10 nm.

The thickness of the alumina layer is preferred to be in a range of from 30 μm to 100 μm. If exceeding 100 μm, the efficiency of using the carried catalyst may be lowered. A preferred range of the thickness of the alumina layer is 40 μm or more and 80 μm or less.

Now, the detail of the second catalyst layer 28 will be described. As shown in FIG. 7, the second catalyst layer 28 is formed in such a manner that at least methanol reforming catalyst 30 and other additives as required are carried on the surface of the alumina layer 29 obtained by anodic oxidation of the surface of the aluminum portion of the second path plate 23. As described above, dimethyl ether is decomposed into methanol by hydrolysis of dimethyl ether as the first stage reaction shown in formula (1), and is reformed into hydrogen and carbon dioxide by steam reformation of methanol as the second stage reaction shown in formula (2). The methanol reforming catalyst is any known catalyst including Cu carrying γ-alumina (Cu/γ-Al₂O₃), copper-zinc catalyst (Cu/ZnO), and palladium or other noble metal-zinc catalyst (for example, Pd/ZnO). Of them, palladium-zinc catalyst (Pd/ZnO) is preferred in particular. The reason is explained below.

First, the inventors have attempted to execute a hydrolysis test of dimethyl ether by use of a plate catalyst having heteropolyacid (silicotungstic acid) carried on an alumina layer formed by anodic oxidation. As a result, it has been found that this catalyst exhibited an excellent activity in hydrolysis of dimethyl ether, that the reaction of hydrolysis was promoted up to the thermodynamic equilibrium value of formula (1) at 250° C., and that the product was mostly composed of methanol. At temperature of 300° C. or higher, the conversion rate of dimethyl ether was slightly higher than the equilibrium conversion rate. It means that dimethyl ether has been converted into other compounds than methanol. As a result of analysis by gas chromatography, very slightly, olefins such as ethylene and propylene were observed. Olefins may have adverse effects on the subsequent fuel cell system, and are not preferred. Next, a reforming test of dimethyl ether was executed in a reformer in which a plate catalyst carrying palladium-zinc (Pd/ZnO) and a plate catalyst having heteropolyacid (silicotungstic acid) carried on the alumina layer are alternately arranged. Similarly, as a result of analysis by gas chromatography, ethylene and propylene were not observed at all. However, when the copper/zinc catalyst (Cu/ZnO) was used as the methanol reforming catalyst, traces of olefins were observed. Therefore, the palladium-zinc catalyst (Pd/ZnO) is preferred as the methanol reforming catalyst to be carried on the second catalyst layer 28.

The method of carrying the methanol reforming catalyst 30 on the alumina layer 29 includes known methods such as an impregnation method, a coprecipitation method, and a wash-coat method. By such methods, the bonding strength of a catalyst layer including a methanol reforming catalyst with the wall is increased, so that the methanol reforming catalyst can be prevented from being peeled off. For example, when palladium-zinc (Pd/ZnO) is carried on the alumina layer 29 as a methanol reforming catalyst by the impregnation method, zinc is first impregnated and carried in the alumina layer 29, palladium is impregnated and carried, and then, the structure is baked at around 400° C.

As the second catalyst layer 28, aside from the configuration mentioned above, for example, the following catalyst layers (1) and (2) can be used.

(1) The second catalyst layer 28 can be formed in such a manner that oxide powder as a base material thereof is molded in a sheet, a catalyst component is impregnated, coprecipitated, or wash-coated on the surface of the molded product, and the layer is baked. The oxide as the base material may be γ-alumina, zinc oxide (ZnO), etc. The methanol reforming catalyst for composing the second catalyst layer 28 may be Cu carrying γ-alumina (Cu/γ-Al₂O₃), copper-zinc catalyst (Cu/ZnO), and palladium or other noble metal-zinc catalyst (for example, Pd/ZnO).

(2) Zinc (Zn) or alloy containing zinc is used at least in part of the base material of the second path plate 23. The second path plate 23 is processed and formed in the same method as in the first path plate 22. The surface of the zinc portion of the second path plate 23 is processed by anodic oxidation or oxidation heating to form a zinc oxide film, and at least one element selected from the group consisting of Pt, pd and Cu is carried on the surface of the obtained zinc oxide film. The method of carrying a catalyst component on the zinc oxide film includes known methods such as an impregnation method, a coprecipitation method, and a wash-coat method.

The reforming unit 5 is heated by the combustion unit 6 such that the temperatures of the first path plate 22 and the second path plate 23 are not lower than 225° C. and not higher than 300° C. At this time, the temperatures of the first path plate 22 and the second path plate 23 can be measured by providing a temperature sensor in the reforming unit 5. However, the width of the parallel path 31 between the first and second path plates 22 and 23 is very small, 500 μm or less, and it may be difficult to install a temperature sensor in the reforming unit 5. In such a case, a temperature sensor is provided on the outer wall of the reforming unit 5, whereby the temperatures of the first path plate 22 and the second path plate 23 are measured indirectly.

Subsequently, the fuel cell 2 will be described below in more detail. The fuel cell 2 includes a fuel electrode 2a, an oxidant electrode 2b, and a proton conductive electrolyte membrane 2c sandwiched between the electrodes 2a and 2b. The fuel electrode 2a is composed of a porous sheet having carbon black powder carrying Pt supported by a water repellent resin binder such as polytetrafluoroethylene (PTFE). The oxidant electrode 2b is composed of a porous sheet similarly having carbon black powder carrying Pt supported by a water repellent resin binder such as polytetrafluoroethylene (PTFE). The electrolyte membrane 2c is composed of a fluorocarbon polymer having a cation exchange group such as sulfonic group or carboxylic group, for example, Nafion (registered trademark of Du Pont). The porous sheet may contain a sulfonic type perfluorocarbon polymer or fine particles coated with such a polymer.

Hydrogen supplied in the fuel electrode 2b reacts in the fuel electrode 2a in accordance with the following reaction formula.

H₂ [symbol] 2H⁺+2e⁻

On the other hand, oxygen supplied in the oxidant electrode 2b reacts in the oxidant electrode 1b in accordance with the following reaction formula.
1/2O₂+2H⁺+2e⁻ [symbol] H₂O

In the reformer of the hydrogen generating device and fuel cell system according to the embodiment of the invention, the first catalyst layer and the second catalyst layer are arranged alternately by fitting and joining penetration groove plates having mutually adjacent grooves formed therein, a penetration groove is formed between them, and the width of the penetration groove is adjusted to 500 μm or less. Accordingly, a reformer which has, in spite of small size, a wide reaction area, and is small in gas diffusion resistance for its wide reaction area can be provided. If a powder catalyst having heteropolyacid carried on alumina particles disclosed in Applied Catalyst, A216, 85-90, 2001, is used as the first catalyst layer, the penetration groove is closed and the pressure loss is increased, so that the reforming rate is lowered. By using, as the first catalyst, a catalyst having heteropolyacid carried on an alumina layer formed by anodic oxidation, decline of pressure loss due to closure of the penetration groove can be avoided, and heat necessary for reaction can be transferred promptly. Consequently, the reforming rate at low temperature of dimethyl ether as the fuel at 300° C. or lower can be improved. As a result, since reforming, CO shifting, and CO removing can be done at substantially the same temperature, the distance for heat insulation among the reforming unit, the CO shifter and the CO removing unit can be shortened, which allows to reduce the size of the hydrogen generating device and fuel cell system.

Moreover, since the reforming rate is improved, the hydrogen generation efficiency of the entire hydrogen generating device can be enhanced, and the power generation efficiency of the fuel cell system can also be improved.

In a so-called plate type reformer, plate catalysts are used for the first and second catalyst layers. For this reason, a penetration groove of 500 μm or less in width can be provided between the plate catalyst of first catalyst layer and the plate catalyst of second catalyst layer. Even when, as the first catalyst layer of the plate type reformer, a catalyst having heteropolyacid carried on the alumina layer formed by anodic oxidation is used, the reforming rate at low temperature of 300° C. or lower could not be improved sufficiently. The following reasons (A) and (B) are estimated.

(A) In the plate type reformer, the first catalyst layer, and the first catalyst layer positioned adjacently to the second catalyst layer across this catalyst layer are independent of each other. Thus, even if the alumina layer formed by anodic oxidation is used, the heat conductivity of the first catalyst layer is not improved sufficiently.

(B) The plate type reformer is smaller in the reaction area per unit volume as compared with the reformer of the embodiment. Therefore, if the catalyst having heteropolyacid carried on the alumina layer formed by anodic oxidation is used in the plate type reformer, the catalyst carrying amount per unit area of the path wall is insufficient.

The description of the foregoing embodiments and the accompanying drawings should not be understood to limit the invention. Various alternative embodiments, examples, and operation technology can be conceived by those skilled in the art from the present disclosure. The hydrogen generating device and fuel cell system according to the embodiments can be applied in manufacture of hydrogen and generation of power in various fields. For example, the vaporizing unit 4, the CO shifter 7, and the CO removing unit 8 may be formed integrally. In this case, the thermal resistance is lowered among the vaporizing unit 4, the CO shifter 7, and the CO removing unit 8, and the amount of hydrogen burned by the combustion unit 6 is curtailed. That is, the hydrogen generation efficiency of the entire hydrogen generating device is enhanced, and the power generation efficiency of the fuel cell system becomes higher.

Examples of the present invention will be described below in detail with reference to the accompanying drawings.

### EXAMPLE A>

### Example 1

A reforming test of dimethyl ether was conducted by use of the hydrogen generating device shown in the first embodiment. The material of the container 21 and the lid 24 was stainless steel (SUS316), and the material of the first path plate 22 and the second path plate 23 was aluminum (A1050).

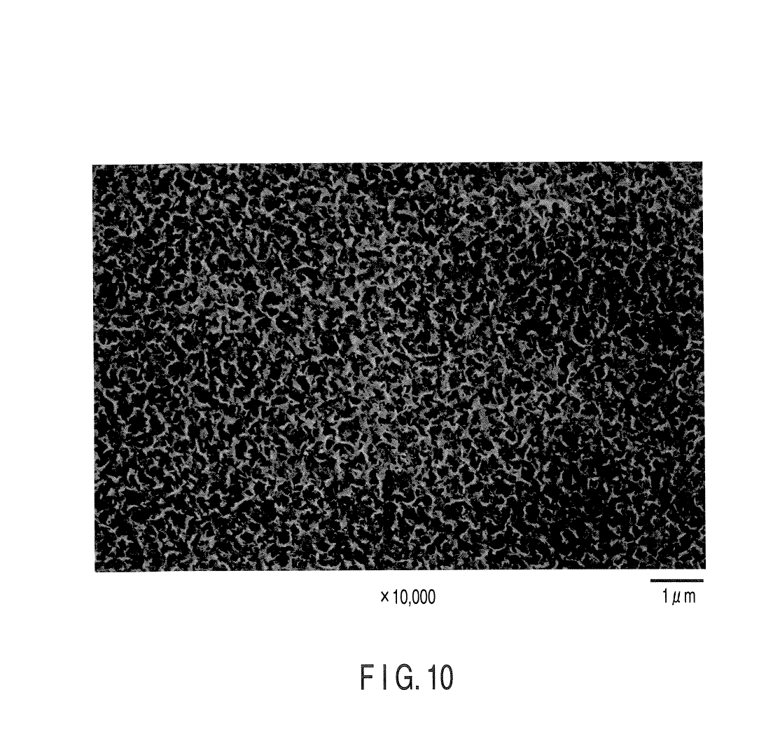

In the first path plate 22 and the second path plate 23, wire discharge cutting was executed to form a parallel path (groove) opening at both ends thereof. As shown in FIG. 9A, a pitch A of the fins (side walls) 22b, 23b is 0.9 mm each, and thickness B of the fins 22b, 23b is 0.3 mm each. A geometrical area of a portion of the fins 22b, 23b to be carried by a catalyst is 150 cm².

On the surface of the first path plate 22, a γ-alumina layer of 80 μm in thickness was formed by anodic oxidation process. The anodic oxidation process was performed as follows. First, in an oxalic acid aqueous solution (3 wt. %) at 25° C., anodic oxidation process was conducted for 18 hours at current density of 50 A/m². The plate was baked at 350° C. and then immersed in the oxalic acid aqueous solution (3 wt. %) at 250° C. for 4 hours, and pores were expanded. After successive burning at 350° C., the plate was immersed in ion exchange water at 85° C. for 2 hours as hot water treatment, and the anodic oxidation film was formed into boehmite. After forming into boehmite, the film was baked for 3 hours at 500° C. or higher, and the boehmite anodic oxidation film was formed into a γ-alumina layer. When the average pore size of the γ-alumina layer was determined by a nitrogen adsorption method, 5 nm was obtained. An electron microscope image (FE-SEM) of the anodic oxidation film is shown in FIG. 10 (10000 times). It has been confirmed from FIG. 10 that the alumina layer has a porous structure, that is, the alumina layer is formed by anodic oxidation.

On the thus manufactured anodic oxidation alumina (γ-alumina), silicotungstic acid (H₄SiW₁₂O₄₀) was carried as heteropolyacid. Silicotungstic acid 12 hydrate manufactured by Wako Pure Chemical Industries, Ltd. was used as the silicotungstic acid, and it was dissolved in ion exchange water to prepare 0.3 mol/L aqueous solution. The first path plate 22 subjected to anodic oxidation process was immersed in the aqueous solution for 16 hours to impregnate, and was dried for 3 hours at 120° C. To measure the carrying amount, tungsten (W) was analyzed quantitatively by an ICP emission spectrophotometer. As a result, the carrying amount per unit geometrical area of the first path plate 22 was 5400 μg/cm².

Next, anodic oxidation alumina (γ-alumina) of 80 μm in average film thickness was formed on the surface of the second path plate 23 in the same manner as in the first path plate 22. The plate was immersed in a zinc nitrate aqueous solution of 3 mol/L for 16 hours, dried at 120° C. for 1 hour, and burned at 500° C. for 3 hours to carry zinc oxide (ZnO) on the anodic oxidation alumina.

The plate was further immersed in an acetone solution (saturated) of palladium acetyl acetonate (Pd(C₅H₇O₂)₂), and impregnated while being refluxed at 50° C., and dried to carry palladium. This operation was repeated 15 times. Then, by burning for 2 hours at 400° C. in an electric furnace in air atmosphere, a palladium-zinc catalyst (Pd/ZnO) was carried on the surface of the second path plate 23.

Subsequently, the first path plate 22 and the second path plate 23 were fit and joined face to face such that the individual fins were arranged alternately, and a penetration groove structure having a parallel path with penetration groove width C of 0.15 mm (150 μm) shown in FIG. 9B was fabricated.

This penetration groove structure was fit into the fitting portion of the container 21, and the lid 24 was placed thereon and welded, whereby a small reformer (reforming unit 5) shown in FIG. 3 was assembled.

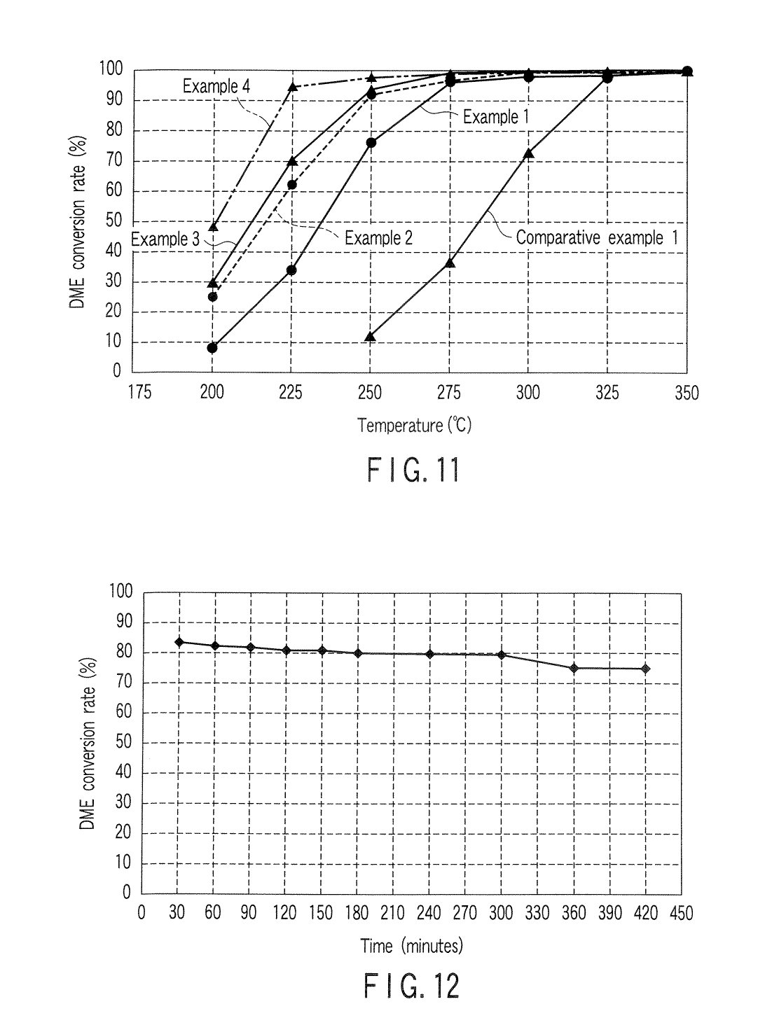

Dimethyl ether and water were supplied in this small reformer, and hydrogen was generated. The flow rate of dimethyl ether was 50 cc/min, and the water was supplied at flow rate of 200 cc/min in a gas state. The temperature of the outer wall of the reforming unit 5 was controlled at 200° C., 225° C., 250° C., 275° C., 300° C., 325° C. and 350° C., the reforming gas at each temperature was analyzed by gas chromatograph, and the conversion rate of dimethyl ether was investigated. Results thereof are shown in FIG. 11. The value of the conversion rate at 275° C. is shown in Table 1.

### Example 1-2

A hydrogen generating device was manufactured in the same manner as in Example 1, except that the width C of the parallel path of the penetration groove structure was set at 500 μm. The value of the conversion rate at 275° C. measured same as in Example 1 is shown in Table 1.

### Example 2

On anodic oxidation alumina (γ-alumina) of a first path plate 22 manufactured in the same manner as in Example 1, phosphotungstic acid (H₃PW₁₂O₄₀) was carried as heteropolyacid. The phosphotungstic acid was 12 tungstophosphoric n hydrate manufactured by Wako Pure Chemical Industries, Ltd. It was dissolved in ion exchange water to prepare an aqueous solution of 0.3 mol/L. The first path plate 22 subjected to anodic oxidation process was immersed in the aqueous solution for 16 hours, and dried for 3 hours at 120° C. When, to measure the carrying amount, tungsten (W) was analyzed quantitatively by an ICP emission spectrophotometer, the carrying amount per unit geometrical area of the first path plate 22 was 3400 μg/cm².

A hydrogen generating device was manufactured in the same manner as in Example 1. Same as in Example 1, a reforming test of dimethyl ether was conducted, and the conversion rate of dimethyl ether was investigated. Results thereof are shown in FIG. 11. The value of the conversion rate at 275° C. is shown in Table 1.

### Example 3

Anodic oxidation alumina (γ-alumina) of 80 μm in average film thickness was formed on the surface of a second path plate 23 in the same manner as in the first path plate 22 shown in Example 1, and a copper-zinc catalyst (Cu/ZnO) was carried thereon as a methanol reforming catalyst. A hydrogen generating device was manufactured in the same manner as in Example 1, except for the points mentioned above. Same as in Example 1, a reforming test of dimethyl ether was conducted 1, and the conversion rate of dimethyl ether was investigated. Results thereof are shown in FIG. 11. The value of the conversion rate at 275° C. is shown in Table 1.

### Example 4

Anodic oxidation alumina (γ-alumina) of 80 μm in average film thickness was formed on the surface of a second path plate 23 in the same manner as in the first path plate 22 shown in Example 1, and a copper-zinc catalyst (Cu/ZnO) was carried thereon as a methanol reforming catalyst. A hydrogen generating device was manufactured in the same manner as in Example 2, except for the points mentioned above. Same as in Example 1, a reforming test of dimethyl ether was conducted, and the conversion rate of dimethyl ether was investigated. Results thereof are shown in FIG. 11. The value of the conversion rate at 275° C. is shown in Table 1.

### Comparative Example 1

On the surface of a first path plate 22 manufactured in the same manner as in Example 1, anodic oxidation alumina (γ-alumina) of 80 μm in average film thickness was formed in the same manner as in Example 1. However, heteropolyacid was not carried. A hydrogen generating device was manufactured in the same manner as in Example 1, except for the points mentioned above. Same as in Example 1, a reforming test of dimethyl ether was conducted, and the conversion rate of dimethyl ether was investigated. Results thereof are shown in FIG. 11. The value of the conversion rate at 275° C. is shown in Table 1.

### Comparative Example 2

On the surface of a first path plate 22 manufactured in the same manner as in Example 1, a mixed slurry of a powder catalyst including γ-alumina powder with a known alumina binder was prepared, and applied and dried repeatedly, and baked to form a γ-alumina layer of 80 μm in thickness. The 7-alumina powder was high purity alumina which is a commercial product (AKP-G015 manufactured by Sumitomo Chemical Co., Ltd., center particle size <0.1 μm). On the γ-alumina layer, silicotungstic acid (H₄SiW₁₂O₄₀) was carried as heteropolyacid in the same manner as in Example 1. The carrying amount was 50 wt. % with respect to γ-alumina.

In the finished penetration groove plate, however, closure of the penetration groove and peeling of the catalyst layer were observed. It was attempted to fit and join the first path plate 22 thus fabricated, and the second path plate 23 manufactured in the same manner as in Example 1 face to face so as to arrange the individual penetration groove fins alternately. However, the closure of the penetration grooves was significant, and a penetration groove structure could not be formed.

### Comparative Example 2-2

On the surface of a first path plate 22 manufactured in the same manner as in Example 1-2, a γ-alumina layer was formed in the same manner as in Comparative example 2. Further, in the same manner as in Comparative example 2, silicotungstic acid (H₄SiW₁₂O₄₀) was carried on the γ-alumina layer as heteropolyacid. The obtained first path plate 22, and the second path plate 23 carrying the catalyst in the same manner as in Example 1 were arranged such that the width C of the parallel path (groove) of the penetration groove structure was 500 μm.

A hydrogen generating device was manufactured in the same manner as in Example 1, except for the points mentioned above. The conversion rate at 275° C. was measured in the same manner as in Example 1, and the obtained value is shown in Table 1.

### Comparative Example 3

A hydrogen generating device was manufactured in the same manner as in Example 1, except that the width C of the parallel penetration groove of the penetration groove structure was increased from 500 μm to 1 mm. The value of the conversion rate measured at 275° C. in the same manner as in Example 1 is shown in Table 1.

TABLE 1

| | DME Conversion |
|---|---|
| | rate at 275° C. (%) |
| Example 1 | 96 |
| Example 1-2 | 94 |
| Example 2 | 97 |
| Example 3 | 99 |
| Example 4 | 99 |
| Comparative Example 1 | 36 |
| Comparative Example 2-2 | 79 |
| Comparative Example 3 | 85 |

As clear from Table 1, in Examples 1, 1-2, 2, 3 and 4, the conversion rate of dimethyl ether at 275° C. was high, 94% or more. It has been also known from FIG. 11 that the conversion rate of dimethyl ether at 300° C. in Examples 1, 2, 3 and 4 is almost 100%. In particular, in Example 4, the conversion rate at even 225° C. was 94%.

In Comparative example 1, by contrast, the conversion rate at 275° C. was 36%, and the conversion rate at 300° C. was about 73%, which were much lower than those in Examples 1 to 4. Further, when γ-alumina powder is used as a carrier as in Comparative examples 2 and 2-2, a penetration groove structure could not be formed if the width of the penetration groove was defined at 150 μm as in Example 1. In addition, in the penetration groove structure of Comparative example 2-2 having the width of the penetration groove extended to 500 μm, the conversion rate at 275° C. was lower than that in the examples. Even when the anodic oxidation alumina was used, the conversion rate at 275° C. was inferior as compared with that of the examples in the case where the width of the penetration groove exceeded 500 μm as in Comparative example 3.

After the reforming test of dimethyl ether shown in FIG. 11, the reformers of the hydrogen generating devices of Examples 1 and 3 were exposed to the atmosphere and purged with nitrogen, and then, the reforming test of dimethyl ether was attempted again. As a result, in the hydrogen generating device of Example 1, no change was noted in the initial conversion rate. By contrast, in the hydrogen generating device in Example 3, the initial conversion rate was lowered to 84% as shown in FIG. 12.

### EXAMPLE B

### Example 5

In order to constitute a fuel cell system having the configuration as shown in FIG. 1, a CO shift unit and a CO removing unit were connected to a reforming unit manufactured in the method shown in Example 1. In the CO shift unit, Pt, Re, CeO₂ were carried on anodic oxidation alumina (γ-alumina) manufactured in the same manner as in Example 1 to be used as a catalyst unit. In the CO removing unit, ruthenium (Ru) was impregnated and carried on anodic oxidation alumina (γ-alumina) manufactured in the same manner as in Example 1 to be used as a catalyst unit.

Then, it was contained in a vacuum insulating container, the temperature of the reforming unit was controlled at 300° C., and the temperature of the CO shift unit and CO removing unit was controlled at 250° C., so that hydrogen generation was tested by dimethyl ether reforming.

Herein, a mixture of dimethyl ether, water and methanol at molar ratio of 1:4:0.18 was used as the fuel.

The generation amount of the obtained reformed gas and the CO concentration in the reformed gas are shown in Table 2. When the obtained reformed gas was supplied in a fuel cell stack having a rated output of 20 W and operation was performed at temperature of 80° C., a rated output was obtained (20 W).

### Example 6

A first path plate manufactured by the method shown in Example 1 was prepared.

Zinc oxide (ZnO) was used as a base material of a second path plate. Powder of the zinc oxide was molded in a rectangular shape and baked, and thereafter, the surface of the molded product was processed by a multiblade saw to form a penetration groove (groove) opening at both ends thereof. In this way, the second path plate having the same shape as the second path plate shown in Example 1 was formed.

Palladium was carried on the second path plate formed of zinc oxide in the same manner as in Example 1. Thereafter, by baking for 2 hours at 400° C. in an electric furnace in air atmosphere, palladium-zinc catalyst (Pd/ZnO) was carried on the surface of the second path plate.

The first path plate and second path plate manufactured as described above were fit and joined such that the penetration groove fins were arranged alternately, and a penetration groove structure having a parallel penetration groove with the penetration groove width C of 0.15 mm (150 μm) was constituted.

This penetration groove structure was fit into the fitting portion of the container, and the lid was placed thereon and welded, whereby a small reformer (reforming unit) shown in FIG. 3 was assembled.

The CO shift unit and CO removing unit were connected to the thus formed reformer, and accommodated in a vacuum insulating container, and hydrogen generation experiment was conducted by dimethyl ether reforming. The condition was same as that in Example 5. The generation amount of the obtained reformed gas and the CO concentration in the reformed gas are shown in Table 2. When the obtained reformed gas was supplied in a fuel cell stack having a rated output of 20 W and operation was performed at temperature of 80° C., a rated output was obtained (20 W).

### Example 7

A first path plate manufactured by the method shown in Example 1 was prepared.

As a second path plate, a second path plate which was formed of aluminum-zinc alloy (55% Al-45% Zn) and had exactly the same shape as the second path plate in Example 1 was prepared. On the surface of the second path plate, an anodic oxidation film of zinc was formed by anodic oxidation process. In the anodic oxidation processing, power was supplied for 10 minutes at current density of 15 A/dm² in a chromic acid aqueous solution adjusted to pH 12.8, and an anodic oxidation film including a zinc oxide layer (ZnO) was formed. The thickness of the anodic oxidation film was 45 μm.

Pd was impregnated and carried on the second path plate in the same manner as in Example 1. Then, by baking for 2 hours at 400° C. in an electric furnace in air atmosphere, a palladium-zinc catalyst (Pd/ZnO) was carried on the surface of the second path plate.

The first path plate and second path plate manufactured as described above were fit and joined such that the fins were arranged alternately, and a penetration groove structure having a parallel path with the penetration groove width C of 0.15 mm (150 μm) was constituted.

This penetration groove structure was fit into the fitting portion of the container, and the lid was placed thereon and welded, whereby a small reformer (reforming unit) shown in FIG. 3 was assembled.

The CO shift unit and CO removing unit were connected to the thus formed reformer, and accommodated in a vacuum insulating container, and hydrogen generation experiment was conducted by dimethyl ether reforming. The condition was same as that in Example 5. The generation amount of the obtained reformed gas and the CO concentration in the reformed gas are shown in Table 2. When the obtained reformed gas was supplied in a fuel cell stack having a rated output of 20 W and operation was performed at temperature of 80° C., a rated output was obtained (20 W).

### Comparative Example 4

A first path plate was manufactured in the same manner as in Example 1. On the surface of the first path plate, anodic oxidation alumina (γ-alumina) of 80 μm in average film thickness was formed same as in Example 1. However, heteropolyacid was not carried.

A second path plate was manufactured in the same manner as in Example 1. On the surface of the second path plate, anodic oxidation alumina (γ-alumina) of 80 μm in average film thickness was formed same as in Example 1. Further, zinc oxide (ZnO) and palladium (Pd) were carried in the same manner as in Example 1. Then, by baking for 2 hours at 400° C. in an electric furnace in air atmosphere, a palladium-zinc catalyst (Pd/ZnO) was carried on the surface of the second path plate.

The first path plate and second path plate manufactured as described above were fit and joined such that the penetration groove fins were arranged alternately, and a penetration groove structure having a parallel penetration groove with the penetration groove width C of 0.15 mm (150 μm) was constituted.

This penetration groove structure was fit into the fitting portion of the container, and the lid was placed thereon and welded, whereby a small reformer (reforming unit 5) shown in FIG. 3 was assembled.

The CO shifter and CO removing unit were connected to the thus formed reformer, and accommodated in a vacuum insulating container, and hydrogen generation experiment was conducted by dimethyl ether reforming. The temperature of the reforming unit was controlled at 350° C. such that the ME conversion rate was 1000, and the temperature of the CO shifter and CO removing unit was controlled at 250° C. However, due to heat transfer from the reforming unit, the temperature of the CO shifter and CO removing unit was elevated, and exceeded the control temperature of 250° C. When the temperature of the upstream portion of the CO shifter was measured, it was 290° C.

The generation amount of the obtained reformed gas and the CO concentration in the reformed gas are shown in Table 2. The CO concentration climbed to 500 to 850 ppm. When the obtained reformed gas was supplied in a fuel cell stack having a rated output of 20 W, the output dropped suddenly, and power generation was shortly disabled.

TABLE 2

| | Amount of | |
|---|---|---|
| | hydrogen | |
| | generation | CO Concentration |
| | (cc/min) | (ppm) |
| Example 5 | 250 | 29 |
| Example 6 | 250 | 33 |
| Example 7 | 248 | 31 |
| Comparative | 223 | 500-850 |
| Example 4 | | |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A hydrogen generating device comprising a reforming unit to obtain reformed gas containing hydrogen from a fuel containing dimethyl ether and water, the reforming unit comprising:
a first path plate having a plurality of first penetration grooves adjacent to one another, a plurality of first walls which define the first penetration grooves, and an alumina layer formed by anodic oxidation at least in part of the surface of the first walls, and a first catalyst layer containing heteropolyacid to be carried on the alumina layer; and
a second path plate arranged oppositely to the first path plate, the second path plate having a plurality of second penetration grooves formed so as to correspond to the first penetration grooves one by one, a plurality of second walls which define the second penetration grooves, and a second catalyst layer formed at least in part of the surface of the second walls,
wherein the first walls are inserted into the second penetration grooves, and the second walls are inserted into the first penetration grooves, whereby the first walls and second walls are located opposite to each other and apart from each other by not larger than 500 μm inclusive 500 μm, respectively.

2. The device according to claim 1,
wherein the second catalyst layer includes a methanol reforming catalyst.

3. The device according to claim 1,
wherein the second catalyst layer includes a zinc oxide layer formed at least in part of the surface of the second walls, and at least one element selected from the group consisting of Pt, Pd and Cu, said at least one element being carried on the zinc oxide layer.

4. The device according to claim 1,
wherein the second catalyst layer includes a palladium-zinc (Pd/ZnO) catalyst.

5. The device according to claim 1,
wherein the alumina layer includes γ-alumina having an average pore size not smaller than 5 nm and not larger than 10 nm.

6. The device according to claim 1,
wherein the heteropolyacid includes at least one kind selected from the group consisting of phosphotungstic acid, phosphomolybdic acid, and silicotungstic acid.

7. The device according to claim 1, further comprising:
temperature holding means for holding the temperatures of the first path plate and the second path plate within not lower than 225° C. and not higher than 300° C.

8. The device according to claim 1, further comprising:
a container having a fitting portion to accommodate the first and second path plates;
a lid which is attached to the container so as to seal the fitting portion;
a supply port to supply the fuel into the first and second penetration grooves; and
an exhaust port to exhaust the reformed gas from the first and second penetration grooves.

9. A fuel cell system comprising:
a reforming unit to obtain reformed gas including hydrogen from a fuel including dimethyl ether and water; and
a fuel cell which receives supply of the reformed gas,
the reforming unit comprising:
a first path plate having a plurality of first penetration grooves adjacent to one another, a plurality of first walls which define the first penetration grooves, an alumina layer formed by anodic oxidation at least in part of the surface of the first walls, and a first catalyst layer containing heteropolyacid to be carried on the alumina layer; and
a second path plate arranged oppositely to the first path plate, the second path plate having a plurality of second penetration grooves formed so as to correspond to the first penetration grooves one by one, a plurality of second walls which define the second penetration grooves, and a second catalyst layer formed at least in part of the surface of the second walls,
wherein the first walls are inserted into the second penetration grooves, and the second walls are inserted into the first penetration grooves, whereby the first walls and second walls are located opposite to each other and apart from each other by not larger than 500 μm inclusive 500 μm, respectively.

10. The fuel cell system according to claim 9, further comprising:
a container having a fitting portion;
a lid which is attached to the container so as to cover and seal the fitting portion;
a supply port to supply the fuel into the first and second penetration grooves; and
an exhaust port to exhaust the reformed gas from the first and second penetration grooves,
wherein the first and second path plates are fit into the fitting portion.
